(19) United States
(12) Patent Application Publication
(10) Pub. No.: US 2026/0336019 A1
(43) Pub. Date: Oct. 29, 2026

(54) WELDING MASK FOR SECONDARY BATTERY CELL TAB, AND WELDING DEVICE AND METHOD FOR SECONDARY BATTERY CELL TAB INCLUDING SAME

(71) Applicant: SK ON CO., LTD., Seoul (KR)

(72) Inventors: Hyeong-Won KIM, Daejeon (KR); Jae-Hun KIM, Daejeon (KR); HoeMin CHEONG, Daejeon (KR); Sung-Chel YOON, Daejeon (KR); Ki-Dong LEE

(21) Appl. No.: 19/123,069

(22) PCT Filed: Jun. 27, 2023
(86) PCT No.: PCT/KR2023/008966

§ 371 Date: Apr. 22, 2025

(30) Foreign Application Priority Data
Jan. 17, 2023 (KR) 10-2023-0006586

(51) Int. Cl. B23K 26/06; B23K 26/21

(52) U.S. Cl. CPC B23K 26/06; B23K 26/21

(57) ABSTRACT

A welding device for a secondary battery cell tab according to one embodiment of the present invention comprises: a mask for covering the surface of a busbar assembly; a fixing member fixed to the busbar assembly; a support member, which supports the mask and is coupled to the fixing member; and a laser generator for irradiating a laser beam at the busbar assembly, wherein the mask includes a mask body and a plurality of penetration parts penetrating the mask body, and a portion for forming the mask body from among the plurality of penetration parts may form an acute angle with the normal line of the penetration part.

This application is a national stage application of PCT/KR2023/008966 filed on Jun. 27, 2023, which claims priority of Korean patent application number 10-2023-0006586 filed on Jan. 17, 2023. The disclosure of each of the foregoing applications is incorporated herein by reference in its entirety.

### TECHNICAL FIELD

The present disclosure relates to a welding mask for a secondary battery cell tab, a welding device and a method for manufacturing a secondary battery cell tab including the welding mask.

### BACKGROUND ART

Recently, as mobile electronic devices have rapidly become smaller and lighter, demand for secondary batteries as an energy source thereof is rapidly increasing. As the interconversion between chemical energy and electrical energy has been rapidly progressing in the miniaturization and weight reduction of mobile electronic devices, demand for secondary batteries as an energy source thereof has rapidly increased. Secondary batteries refer to batteries that can repeat charging and discharging because the interconversion between chemical energy and electrical energy is reversible.

The secondary battery may include an electrode assembly including a plurality of electrode plates. The electrode assembly may include a cathode plate, an anode plate, and a separator. In this case, electrode tabs are formed in ends of the cathode plate and the anode plate, respectively.

A plurality of secondary batteries may be stacked to form a battery module. A busbar is used to connect each electrode tab in the battery module. A busbar assembly including a plurality of busbars is for connecting each electrode tab, and may be connected to the electrode tab using laser welding, ultrasonic welding, or spot welding.

The busbar assembly may be comprised of a plurality of busbars and a busbar frame in which the plurality of busbars are disposed. When the busbar and the cell tab are bonded by laser welding, the busbar frame in the form of a polymer injection molding may be damaged, and the damage to the busbar frame may deteriorate the quality of the secondary battery.

In order to solve the problem, there is a method of utilizing an inert gas, a protective gas (e. g., nitrogen, argon, etc.), but this has the problem that the method cannot be performed equally in all processes. In addition, there is a method of designing the busbar assembly by separating a portion in which the busbar and the electrode tab are welded from the busbar frame as much as possible, but this is inefficient in terms of space utilization of the battery module.

### SUMMARY OF INVENTION

### Technical Problem

The present disclosure is to provide a welding mask for a secondary battery cell tab that protects a component in the form of an unwelded injection molded product and prevents a decrease in the performance of a battery module, when welding the secondary battery cell tab and a bus bar, and a welding device and method for a secondary battery cell tab including the same.

Additionally, the present disclosure is to provide a welding mask for a secondary battery cell tab preventing damage to the mask due to welding of the secondary battery cell tab and a bus bar and extending a lifespan of the mask, and a welding device and method for a secondary battery cell tab including the same.

### Solution to Problem

A welding device for a secondary battery cell tab according to an embodiment of the present disclosure may include: a mask covering a surface of a busbar assembly; a fixing member fixed to the busbar assembly; a support member supporting the mask and coupled to the fixing member; and a laser generator irradiating a laser to the busbar assembly, wherein the mask may include: a mask body; and a plurality of penetration parts penetrating through the mask body, and a portion for forming the mask body between the plurality of penetration parts forms an acute angle with a normal line of the penetration parts.

The welding device for a secondary battery cell tab may further include: a driver moving the laser generator so that the laser is able to be irradiated to the plurality of penetration parts.

The laser generator may be configured to irradiate a laser while moving in a first direction and a second direction, perpendicular to the first direction.

The support member of the mask may be formed to be detachable from the fixing member.

The support member may include a detachable controller that attaches the supporting member to the fixing member when laser irradiation starts by the laser generator, and detaches the supporting member from the fixing member when laser emission is terminated.

The support member may include a first support member coupled to the mask in a first direction; and two second support members coupled in a second direction, perpendicular to the first direction, wherein the first support member is disposed between the two second support members.

The fixing member may include a fixing pin inserted into a groove formed in the busbar assembly.

A welding mask for a secondary battery cell tab according to an embodiment of the present disclosure may include: a plurality of blocking portions covering a surface of a busbar assembly coupled to a plurality of secondary battery cells; and a plurality of penetration parts having a perforated shaped through which the laser is irradiated to a cell tab withdrawn from the plurality of secondary battery cells, wherein the plurality of blocking portions and the plurality of penetration parts are alternately disposed, and the plurality of blocking portions form an acute angle with a normal line of the penetration parts.

The blocking portion may include: a first surface parallel to the penetration part; and a second surface and a third surface formed on both sides of the first surface and formed to be inclined with respect to the first surface.

A height of the blocking portion may be 2 mm or more and less than 5.8 mm, and at least one of an angle formed by the normal line of the penetration part and the second surface, and an angle formed by the normal line of the penetration part and the third surface may be 14 degrees or more and less than 50 degrees.

When a distance between an optical path of the laser and the second surface of one blocking portion of the plurality of blocking portions may be referred to as a, a distance between an optical path of the laser and the third surface of the blocking portion adjacent to the one blocking portion may be referred to as b, and a gap between the two blocking portions may be referred to as c, c may be set to satisfy a condition of 0.5 mm≤a≤2.7 mm and 0.5 mm≤b≤2.7 mm.

The mask may include a beryllium copper material.

The mask may include a ceramic material.

The mask may include a material having a light absorption rate absorbing less than 5% of a used laser light.

A welding method for a secondary battery cell tab according to an embodiment of the present disclosure may include: disposing a busbar assembly in a tab of a plurality of secondary battery cells; disposing a mask covering a surface of the busbar assembly; and moving a laser generator and irradiating a laser to the tab of the plurality of secondary battery cells, wherein in the disposing the mask, the mask may include a plurality of penetration parts formed on a body of the mask and having a perforated shape, and a portion for forming the 1 body of the mask between the plurality of penetration parts may be formed to form an acute angle with the normal line of the penetration part.

In the irradiating the laser, the laser may be irradiated to the tab through the plurality of penetration parts.

The welding method for a secondary battery cell tab may further include: removing the mask disposed after a process is completed.

A distance between an optical path in which the laser is irradiated and the portion for forming the body of the mask between the plurality of penetration parts may be 1 mm or more and 2.7 mm or less.

Advantageous Effects of Invention According to an embodiment of the present disclosure, when welding a secondary battery cell tab and a bus bar, the bus bar frame in which a plurality of bus bars are disposed may be protected, thereby preventing degradation of the performance of the battery module.

In addition, according to an embodiment of the present disclosure, damage to a mask due to welding of a secondary battery cell tab and a bus bar may be prevented, thereby increasing the lifespan of the mask.

### BRIEF DESCRIPTION OF DRAWINGS

FIG. 1 is a perspective view illustrating a welding device for a secondary battery cell tab according to an embodiment of the present disclosure.

FIG. 2 illustrates a welding device of a secondary battery cell tab in a state in which a support member and a fixing member of the present disclosure are coupled.

FIG. 3 illustrates an upper fixing pin, a lower fixing pin and a bus bar assembly.

FIG. 4 illustrates a structure in which a mask of the present disclosure is coupled to a support member.

FIG. 5 is a perspective view illustrating a mask of the present disclosure.

FIG. 6 illustrates an effect according to a shape of the mask of the present disclosure.

FIG. 7 illustrates a state in which a bus bar assembly is coupled to a plurality of secondary battery cells.

FIG. 8 illustrates a process of fixing a bus bar assembly by a lower fixing pin.

FIG. 9 illustrates a process in which a fixing member is fixed to a bus bar assembly by an upper fixing pin.

FIG. 10 illustrates a process of coupling a mask and a supporting member of the present disclosure to a bus bar assembly.

FIG. 11 illustrates an operation of irradiating a laser.

### BEST MODE FOR INVENTION

Prior to describing embodiments of the present disclosure in detail, it should be understood that the terms used in the specification and the appended claims should not be construed as being limited to general and dictionary meanings, but interpreted based on the meanings and concepts corresponding to technical aspects of the present disclosure on the basis of the principle that the inventor is allowed to define terms appropriately for the best explanation. Therefore, it should be understood that the embodiments described in this specification and the configurations illustrated in the drawings are only the most desirable embodiments of the disclosed technology and do not represent all the technical concepts of disclosed technology, and accordingly, there may be various equivalents and variations that may replace the embodiments and the configurations of the disclosed technology at the time of this application.

Hereinafter, with reference to the drawings, specific embodiments of the present disclosure will be described. In this case, it should be noted that in the attached drawings, identical components are indicated by identical symbols whenever possible. Additionally, detailed descriptions of well-known functions and configurations that may obscure the gist of the present disclosure will be omitted. For the same reason, some components are exaggerated, omitted, or schematically depicted in the accompanying drawings, and the size of each component does not entirely reflect its actual size.

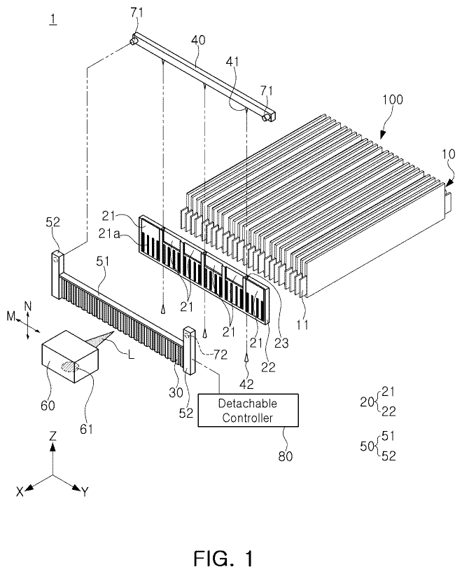

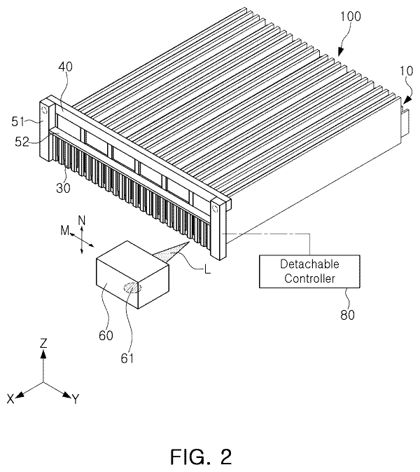

FIG. 1 is a perspective view illustrating a welding device 1 for a secondary battery cell tab according to an embodiment of the present disclosure. FIG. 2 illustrates a welding device 1 for a secondary battery cell tab in a state in which a support member 50 and a fixing member 40 of the present disclosure are coupled.

The welding device 1 for a secondary battery cell tab of the present disclosure is a device welding cell tabs 11 and bus bars 21 respectively provided in a plurality of secondary battery cells 10. A plurality of secondary battery cells 10 may include a plurality of cell tabs 11. The plurality of secondary battery cells 10 are stacked in one direction, and the plurality of cell tabs 11 withdrawn from the plurality of secondary battery cells 10 face a direction, perpendicular to the one direction. For example, referring to FIG. 1, the plurality of secondary battery cells 10 are stacked in the Y-axis direction, and the plurality of cell tabs 11 face an X-axis direction. The plurality of cell tabs 11 may be coupled to a busbar assembly 20.

When the plurality O f busbars 21 of the busbar assembly 20 and the cell tabs 11 are welded, ae polymer injection molded portion (e.g., ‘a busbar frame 22’ to be described below) of the busbar assembly 20 may be damaged by a laser or plasma. For example, the busbar frame 22 may be damaged by at least one of a reflection beam of a laser or heat of plasma. Accordingly, the present disclosure is to protect a portion of a busbar assembly 20 in which welding is not performed, by disposing a mask 30 on a surface of the busbar assembly 20 when welding the cell tabs 11 and the busbars 21. In this document, a laser may refer to laser light or a laser beam.

Referring to FIG. 1, a welding device 1 of a cell tab according to an embodiment of the present disclosure includes a mask 30 covering a surface of a busbar assembly 20, a fixing member 40 fixed to the busbar assembly 20, a support member 50 supporting the mask 30 and coupled to the fixing member 40, and a laser generator 60.

The mask 30 may be disposed between the laser generator 60 and a secondary battery cell stack 100. The mask 30 is a light control means that selectively blocks or reflects a laser output from the laser generator 60. The welding of a plurality of cell tabs 11 and a plurality of busbars 21 may be performed in a state in which the mask 30 is spaced apart from the secondary battery cell stack 100 by a certain distance, or the welding thereof may be performed in a state in which the mask 30 and the secondary battery cell stack 100 are in close contact with each other.

The mask 30 serves to cover the surface of the busbar assembly 20 and protect the busbar assembly 20 during the welding. A specific description of the shape of the mask 30 will be described below.

The busbar assembly 20 is coupled to the secondary battery cell stack 100 so that the cell tabs 11 are exposed. The busbar assembly 20 may include a plurality of busbars 21 and a busbar frame 22 in which the plurality of busbars 21 are disposed. The plurality of busbars 21 may be formed of a conductive material such as copper, and the busbar frame 22 may be in the form of a polymer injection molding. The plurality of busbars 21 and the busbar frame 22 may include a plurality of grooves 21a so that the cell tabs 11 are exposed. In other words, a portion of the cell tabs 11 in which the welding is performed may be exposed through the plurality of grooves 21a. The grooves 21a formed on the plurality of bus bars 21 may be formed to correspond to the plurality of cell tabs 11. The grooves (not illustrated) formed on the bus bar frame 22 may be formed to correspond to the grooves formed on the plurality of bus bars 21, or may be formed to be greater than the grooves formed on the plurality of bus bars 21.

The fixing member 40 may fix the bus bar assembly 20. The fixing member 40 may maintain the bus bar assembly 20 in a fixed state in order to dispose a mask 30 to be described below in an appropriate position.

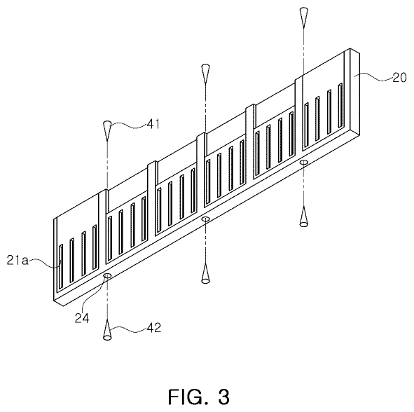

FIG. 3 illustrates an upper fixing pin 41, a lower fixing pin 42, and a bus bar assembly 20.

Referring to FIG. 1 and FIG. 3, the fixing member 40 may include an upper fixing pin 41 fixing the bus bar assembly 20. The fixing member 40 may fix the busbar assembly 20 by inserting the upper fixing pin 41 into a first groove 23 formed in the busbar assembly 20.

The lower fixing pin 42 may be coupled to a lower portion of the busbar assembly 20. A second groove 24 into which the lower fixing pin 42 may be inserted may be formed in a lower portion of the busbar assembly 20.

According to an embodiment, a plurality of first grooves 23 into which the upper fixing pin 41 is inserted and a plurality of second grooves 24 into which the lower fixing pin 42 is inserted may be formed in the busbar frame 22 so as to form a pair with each other and form one axis, respectively. For example, referring to FIG. 3, three first grooves 23 (see FIG. 1) and three second grooves 24 are disposed on an upper portion and a lower portion of the busbar frame 22, and the first groove 23 and the second groove 24 disposed in positions corresponding to each other may form an axis, so that a total of three axes may be disposed side by side. Positions of the first groove 23 and the second groove 24 may be disposed to correspond to an upper portion and a lower portion of the busbar frame 22, the busbar assembly 20 may be firmly fixed. However, the positions of the first groove 23 and the second groove 24 may be designed selectively. For example, in an embodiment not illustrated, the first groove 23 may be disposed on an axis, parallel to the second groove 24.

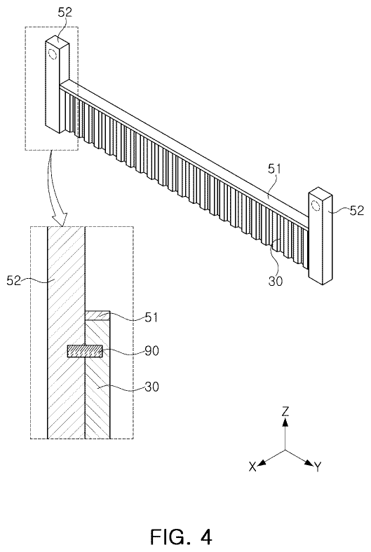

FIG. 4 illustrates a structure in which a mask 30 of the present disclosure is coupled to a support member 50. Referring to FIGS. 1 and 4, the support member 50 will be described.

The support member 50 may be coupled to the mask 30 to support the mask 30. The support member 50 may include a first support member 51 having a length in a first direction (Y-axis) and two second support members 52 coupled in a second direction (Z-axis), perpendicular to the first direction (Y-axis). The first support member 51 may be disposed between the two second support members 52. For example, the mask 30 may be disposed in a space between the two second support members 52 and may be in contact with both the first support member 51 and the second support member 52.

Referring to FIG. 4, the support member 50 may be bolted to the mask 30. For example, a nut to which a bolt 90 may be coupled may be formed in the second support member 52, and the bolt 90 formed integrally with the mask 30 may be coupled to the nut. The coupling structure of FIG. 4 is merely an example, and the coupling structure of the support member 50 and the mask 30 may be variously changed.

The support member 50 may be formed to be detachable from the fixing member 40. For example, the support member 50 may be attached to or detached from the fixing member 40 by magnetic force of a first magnetic member 71 disposed on the fixing member 40 and a second magnetic member 72 disposed on the support member 50.

Additionally, the support member 50 may be provided with a detachable controller 80 controlling an attachment and a detachment of the support member 50. The support member 50 including the detachment controller 80 may include a detachable driving structure (not illustrated) in which the support member 50 is automatically attached when laser emission starts by the laser generator 60 described below, and is automatically detached when the laser emission is terminated.

Referring to FIGS. 1 and 2, the laser generator 60 irradiates a laser (L) at the busbar assembly 20 to weld a plurality of cell tabs 11 and a plurality of busbars 21. The laser generator 60 may include a driver 61 that moves the laser generator 60 so that the laser (L) may be irradiated to a portion (penetration part) of the mask 30 described below. The laser generator 60 may move in one direction and in a direction, perpendicular to the one direction by the driver 61, and may irradiate the laser. For example, the laser generator 60 may move in the Y-axis (M-direction) and the Z-axis (N-direction) by the driver 61, and the laser (L) may be irradiated within a certain range in the Z-axis direction.

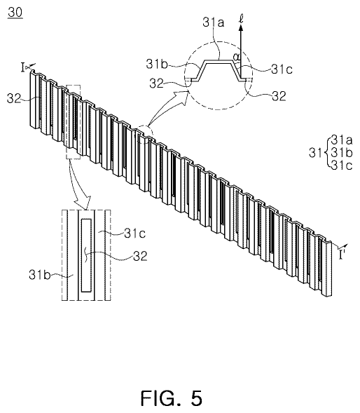

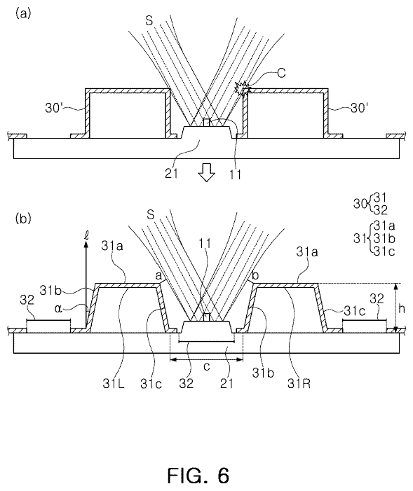

FIG. 5 is a perspective view illustrating a mask 30 of the present disclosure, and FIG. 6 illustrates an effect according to a shape of the mask 30 of the present disclosure.

The mask 30 according to an embodiment of the present disclosure may include a mask body and a plurality of penetration parts 32 penetrating through a mask body. A portion for forming the mask body between the plurality of penetration parts 32 may form a plurality of blocking portions 31. Referring to FIG. 1 and FIG. 5, the plurality of blocking portions 31 may cover a surface of the busbar assembly 20 coupled to a plurality of secondary battery cells 10. The plurality of penetration parts 32 may be a perforated shaped through which the laser may be irradiated to the cell tabs 11 withdrawn from the plurality of secondary battery cells 10. The plurality of blocking portions 31 and the plurality of penetration parts 32 may be disposed alternately.

The plurality of blocking portions 31 may form a constant angle (α) with a normal line [symbol] of the plurality of penetration parts 32. The plurality of blocking portions 31 may form a tapered shape. For example, the angle (α) may form an acute angle. The blocking portion 31 may include a first surface 31a, parallel to the penetration part 32, and a second surface 31b and a third surface 31c formed on both sides of the first surface 31a and formed to be inclined with respect to the first surface 31a. That is, the two inclined surfaces (the second surface 31b and the third surface 31c) are disposed to face each other, and one surface (the first surface 31a) connects the two inclined surfaces (the second surface 31b and the third surface 31c). For example, a height (h) of the blocking portion 31 may be 2 mm or more and less than 5.8 mm (see FIG. 6B). The height (h) of the blocking portion 31 may be formed to be 2 mm or more, thereby protecting the busbar assembly 20. For example, the blocking portion 31 having the height (h) greater than or equal to a specified length may prevent a laser beam from being transmitted to an unintended portion of the busbar assembly 20. The height (h) of the blocking portion 31 may be selectively changed according to the design of the busbar assembly 20. Additionally, at least one (α) of an angle formed by the normal line [symbol] of the penetration part 32 and the second surface 31b and an angle by the normal line [symbol] of the penetration part 32 and the third surface 31c may be 14 degrees or more and less than 50 degrees. Since at least one angle (α) of the angles formed by the normal line [symbol] of the penetration part 32 and the third surface 31c is formed to be 14 to 50 degrees, the shortest distance between an optical path (S) through which the laser is irradiated and the mask 30 may be formed to be a specified distance (e. g., 1 mm) or more. Since the mask 30 and the optical path (S) are formed to have a specified distance or more, interference of the mask 30 with the optical path (S) may be reduced.

Referring to FIG. 6, an effect according to the shape of the blocking portion 31 of the present disclosure will be described. FIG. 6A illustrates a shape of a general mask, and FIG. 6B is a portion of a cross-sectional view taken along line I-I′ of FIG. 5.

FIG. 6A illustrates a shape of a mask 30′ in which a plurality of blocking portions are formed by two surfaces parallel to each other and one surface connecting the two surfaces. In this case, when the laser is irradiated from the laser generator, interference (C) between the laser beam and the mask 30′ may occur, which may damage the mask 30′. On the other hand, referring to FIG. 6B, the blocking portion 31 according to an embodiment of the present disclosure is comprised of two inclined surfaces (second surface 31b and third surface 31c) forming a constant angle (α) with respect to the normal line [symbol] of the penetration part 32, and one surface (first surface 31a) connecting the two inclined surfaces, so that interference between the laser beam and the mask 30 may be minimized. For example, a distance between the optical path (S) through which the laser is irradiated and the blocking portion 31 may be 1 mm or more and 2.7 mm or less. In this case, a distance (α) between the optical path (S) and the blocking portion 31 may refer to a distance between a path of the incident light and a point at which the two inclined surfaces (the second surface 31b and the third surface 31c) of the blocking portion 31 meet the first surface 31a, respectively.

Meanwhile, a gap between the blocking portions 31 should be secured to be a certain distance or more, but a size thereof should be set appropriately. If the gap between the blocking portions 31 is narrow, the incident laser light path (S) may interfere with the blocking portion 31 of the mask 30. Alternatively, if the gap between the blocking portions 31 is excessively wide, when irradiating the laser to an adjacent penetration part 32, the laser may interfere with the blocking portion 31 of the mask 30.

Accordingly, when a distance between the optical path (S) of the laser and a third surface 31c of one blocking portion 31L among the plurality of blocking portions 31 is referred to as a, a distance between the optical path (S) of the laser and a second surface 31b of a blocking portion 31R adjacent to the one blocking portions 31L is referred to as b, and a gap between the two blocking portions 31L and 31R is referred to as c, c may be set to satisfy 0.5 mm≤a≤2.7 mm and 0.5 mm≤b≤2.7 mm.

Meanwhile, the mask 30 may include a material having high thermal conductivity. As the thermal conductivity increases, the heat accumulation inside the mask 30 is reduced, which may reduce damage to the mask 30. For example, the thermal conductivity of the mask 30 may be 80 W/mK or more and 500 W/mK or less. As another example, the thermal conductivity of the mask 30 may be 80 W/mK or less.

Additionally, the mask 30 may be formed of a material having a certain strength. For example, the mask 30 may include a beryllium copper material. For example, a copper material having a lower strength than beryllium copper has significantly weak rigidity, which may increase the possibility of mask bending and damage when manufacturing and using a thin mask. In the case of stainless steel, although stainless steel has a higher strength than beryllium copper, this has a problem of low thermal conductivity. Accordingly, the present disclosure may include a beryllium copper material having a certain strength. However, in the present disclosure, the mask 30 may be changed to various known materials other than beryllium copper as long as this has a higher strength than copper and a thermal conductivity of 80 W/mK or more. However, the mask 30 is not limited to a metal material. For example, in an embodiment, the mask 30 may be formed of ceramic having a higher heat blocking rate than that of metal. When the mask 30 is formed of ceramic, the mask 30 may have a thermal conductivity of 80W/m·K or less.

Additionally, a light absorption rate of the mask 30 is preferably low when considering that the cell tab 11 and the bus bar 21 are welded by laser light. For example, the mask 30 may include a material for absorbing 0.1% or more and less than 5% of the used laser light, or may have a shape or structure for absorbing 0.1% or more and less than 5% of the used laser light.

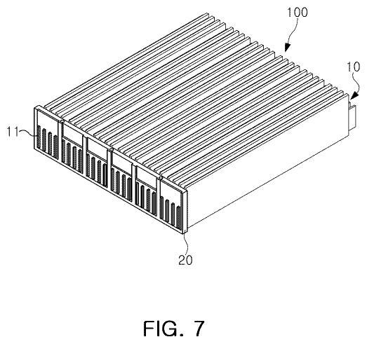

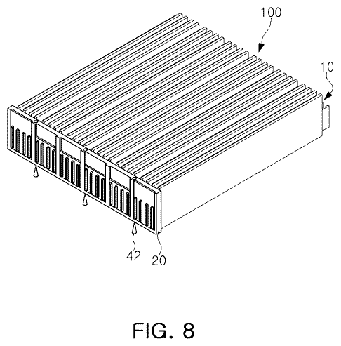

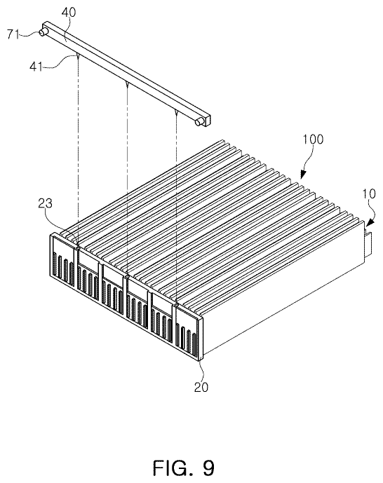

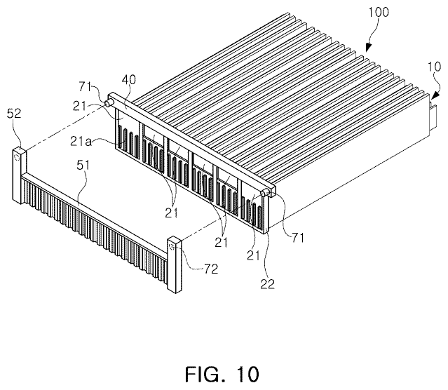

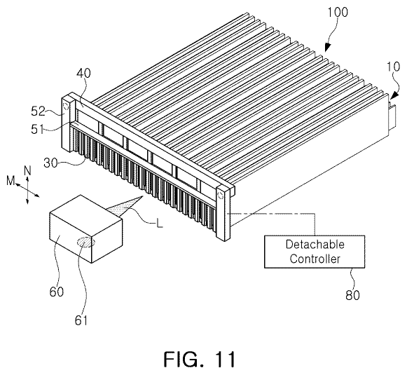

FIGS. 7 to 11 sequentially illustrate a welding method for a secondary battery cell tab according to an embodiment of the present disclosure. FIG. 7 illustrates a state in which a bus bar assembly 20 is coupled to a secondary battery cell 10. FIG. 8 illustrates a process in which a busbar assembly 20 is fixed by a lower fixing pin 42. FIG. 9 illustrates a process in which a fixing member 40 is fixed to a busbar assembly 20 by an upper fixing pin 41. FIG. 10 illustrates a process in which a mask 30 and a support member 50 are coupled to a busbar assembly 20. FIG. 11 illustrates an operation of irradiating a laser (L).

A welding method for a secondary battery cell tab according to an embodiment of the present disclosure may include an operation of disposing a busbar assembly 20 in a tab 11 of a plurality of secondary battery cells 10, disposing a mask 30 covering a surface of a busbar assembly 20, and moving a laser generator 60 and irradiating a laser (L) at the tab 11 of the plurality of secondary battery cells 10.

Referring to FIG. 7, the busbar assembly 20 is assembled to the secondary battery cell stack 100. In this case, the busbar assembly 20 may be assembled so that the plurality of cell tabs 11 are exposed to the outside by through a plurality of grooves penetrating through the busbar assembly 20.

Referring to FIG. 8, a lower fixing pin 42 is coupled to the busbar assembly 20 to fix the busbar assembly 20. A groove (not illustrated) to which the lower fixing pin 42 may be coupled may be formed on a lower surface of the busbar assembly 20. Referring to FIG. 9, a fixing member 40 including an upper fixing pin 41 may fix the busbar assembly 20 to an upper surface of the busbar assembly 20. A groove 23 to which the upper fixing pin 41 may be coupled may be formed on the upper surface of the busbar assembly 20. The upper fixing pin 41 and the lower fixing pin 42 are inserted into the groove formed in the busbar assembly 20 and serve to fix the busbar assembly 20.

Referring to FIG. 10, the mask 30 and the support member 50 may be disposed to cover the surface of the busbar assembly 20. In this case, the support member 50 may be coupled to the fixing member 40 by magnetic attraction of the first magnetic member 71 disposed in the fixing member 40 and the second magnetic member 72 disposed in the support member 50. Accordingly, the mask 30 coupled to the support member 50 may cover the surface of the busbar assembly 20.

Referring to FIG. 11, the fixing member 40 and the support member 50 are bonded to the busbar assembly 20, and the plurality of busbars and the cell tabs is welded by the laser (L) irradiated by the laser generator 60. Referring to FIG. 1, FIG. 6 and FIG. 11, in the operation of irradiating the laser (L), the laser (L) may be irradiated to the plurality of penetration parts 32 penetrating through the body of the mask 30, and the optical path (S) through which the laser (L) is irradiated may be maintained at a certain distance from a portion (the second surface 31b and the third surface 31c of the blocking portion 31 of FIG. 6) forming the body of the mask 30 between the plurality of penetration parts 32. For example, the laser (L) may be irradiated so that the distance between the optical path (S) through which the laser (L) is irradiated and the portion for forming the mask 30 body between the plurality of penetration parts 32 may be 1 mm or more and 2.7 mm less. In addition, the laser generator 60 may irradiate the laser (L) by moving in a left-right direction (M-direction) and an up-down direction (N-direction) by the driver 61.

The welding method for a secondary battery cell tab according to an embodiment of the present disclosure may include an operation of removing the disposed mask 30 after the welding process is completed. The operation of removing the mask may be performed manually or may be automatically removed by the detachable controller 80.

Although the example embodiment of the present disclosure has been described in detail above, it will be obvious to those skilled in the art that the scope of the present disclosure is not limited thereto, and various modifications and variation may be made without departing from the technical concept of the present disclosure described in the claims.

1. A welding device for a secondary battery cell tab, comprising:
a mask covering a surface of a busbar assembly;
a fixing member fixed to the busbar assembly;
a support member supporting the mask and coupled to the fixing member; and
a laser generator irradiating a laser to the busbar assembly,
wherein the mask includes:
a mask body; and
a plurality of penetration parts penetrating through the mask body, and
a portion for forming the mask body between the plurality of penetration parts forms an acute angle with a normal line of the penetration parts.

2. The welding device for a secondary battery cell tab of claim 1, further comprising:
a driver moving the laser generator so that the laser is irradiated to the plurality of penetration parts.

3. The welding device for a secondary battery cell tab of claim 2, wherein the laser generator is configured to irradiate the laser while moving in a first direction and a second direction, perpendicular to the first direction.

4. The welding device for a secondary battery cell tab of claim 1, wherein the support member of the mask is formed to be detachable from the fixing member.

5. The welding device for a secondary battery cell tab of claim 4, wherein the support member includes a detachable controller that attaches the support member to the fixing member when laser irradiation starts by the laser generator, and detaches the support member from the fixing member when laser irradiation is terminated.

6. The welding device for a secondary battery cell tab of claim 4, wherein the support member includes a first support member coupled to the mask in a first direction; and
two second support members coupled in a second direction, perpendicular to the first direction,
wherein the first support member is disposed between the two second support members.

7. The welding device for a secondary battery cell tab of claim 1, wherein the fixing member includes a fixing pin inserted into a groove formed in the busbar assembly.

8. A welding mask for a secondary battery cell tab, comprising:
a plurality of blocking portions covering a surface of a busbar assembly coupled to a plurality of secondary battery cells; and
a plurality of penetration parts having a perforated shaped through which the laser is irradiated to a cell tab withdrawn from the plurality of secondary battery cells,
wherein the plurality of blocking portions and the plurality of penetration parts are alternately disposed, and the plurality of blocking portions form an acute angle with a normal line of the penetration parts.

9. The welding mask for a secondary battery cell tab of claim 8, wherein the blocking portion includes:
a first surface parallel to the penetration part; and
a second surface and a third surface formed on both sides of the first surface and formed to be inclined with respect to the first surface.

10. The welding mask for a secondary battery cell tab of claim 9, wherein a height of the blocking portion is 2 mm or more and less than 5.8 mm, and
at least one of an angle formed by the normal line of the penetration part and the second surface, and an angle formed by the normal line of the penetration part and the third surface is 14 degrees or more and less than 50 degrees.

11. The welding mask for a secondary battery cell tab of claim 9, wherein, when a distance between an optical path of the laser and the second surface of one blocking portion of the plurality of blocking portions is referred to as a, a distance between an optical path of the laser and the third surface of a blocking portion adjacent to the one blocking portion is referred to as b, and a gap between the two blocking portions is referred to as c, c is set to satisfy a condition of 0.5 mm≤a≤2.7 mm and 0.5 mm≤b≤2.7 mm.

12. The welding mask for a secondary battery cell tab of claim 8, wherein the mask includes a beryllium copper material.

13. The welding mask for a secondary battery cell tab of claim 8, wherein the mask includes a ceramic material.

14. The welding mask for a secondary battery cell tab of claim 8, wherein the mask includes a material having a light absorption rate absorbing less than 5% of a used laser light.

15. A welding method for a secondary battery cell tab, comprising:
disposing a busbar assembly in a tab of a plurality of secondary battery cells;
disposing a mask covering a surface of the busbar assembly; and
moving a laser generator and irradiating a laser to the tab of the plurality of secondary battery cells,
wherein in the disposing the mask,
the mask includes a plurality of penetration parts formed on a body of the mask and having a perforated shape, and a portion for forming the body of the mask between the plurality of penetration parts is formed to form an acute angle with the normal line of the penetration part, and
in the irradiating the laser,
the laser is irradiated to the tab through the plurality of penetration parts.
